(19) United States
(12) Patent Application Publication
(10) Pub. No.: US 2004/0157112 A1
(43) Pub. Date: Aug. 12, 2004

(54) Electrode for fuel cell and fuel cell

(76) Inventors: Shuichi Suzuki, Gunma (JP); Yoshihiro Ikoma, Gunma (JP)

Correspondence Address: MCDERMOTT, WILL & EMERY, 600 13th Street, N.W., Washington, DC, 20005-3096, US

(21) Appl. No.: 10/724,404

(22) Filed: Dec. 1, 2003

(30) Foreign Application Priority Data
Dec. 2, 2002 (JP) 2002-349925

(51) Int. Cl. H01M 4/94; H01M 4/96; H01M 8/10

(52) U.S. Cl. 429/44; 429/30

(57) ABSTRACT

There is disclosed an electrode for a fuel cell in which a catalyst utilization is enhanced, and cell performances such as a cell voltage are enhanced, or a catalyst amount can be reduced. For the electrode for the fuel cell of the present invention, carbon particles 323 having small particle sizes are charged onto a conventional gas diffusion layer, and accordingly an arithmetic average roughness Ra of an interface 33 between a catalyst layer 31 and a gas diffusion layer 32 is reduced. When the arithmetic average roughness Ra is small, that is, when the catalyst layer 31 is formed on the flat/smooth gas diffusion layer 32, a reaction gas spreads over the thin and uniform catalyst layer 31, and an utilization of the catalyst layer 31 is enhanced.

### BACKGROUND OF THE INVENTION

1. Field of the Invention

The present invention relates to a fuel cell, especially to a technique of enhancing a catalyst utilization in an electrode for the fuel cell.

2. Description of the Related Art

In general, in many of fuel cells, a constitution includes a basic unit constituted of a cell including an anode disposed opposite to a cathode via an electrolyte. The cell is held between one pair of separators on which ribs and gas channels are formed to comparative example a basic unit, and a plurality of basic units are stacked. Moreover, at the time of run, a fuel gas is supplied to a gas channel on an anode side, air is supplied as an oxidant to the gas channel on a cathode side, and power is generated by electrochemical reaction.

Among the fuel cells, in recent years, a polymer electrolyte fuel cell in which a proton exchange membrance is used as the electrolyte has attracted attentions in that operation is possible at a low temperature and with a superior performance.

In the polymer electrolyte fuel cell, in order to secure ion conductivity of the proton exchange membrance at the time of the operation, a proton exchange membrance needs to be humidified.

Moreover, in this fuel cell, in order to obtain performances of the cell such as a cell voltage, it is important to uniformly spread a fuel gas or an oxidant gas over the whole catalyst layers of the anode and cathode. In consideration of this respect, in the anode and cathode, usually, a gas diffusion layer constituted of carbon paper is stacked between the catalyst layer disposed in contact with the electrolyte and the plate. Moreover, a gas circulated in a gas channel of each plate is supplied to the catalyst layer via the gas diffusion layer, and the gas easily spreads over the whole catalyst layer.

In this manner, various inventions have heretofore been developed with respect to the gas diffusion layer in order to enhance water dragging property together with gas diffusion property. For example, in Japanese Patent Application Laid-Open No. 10-289732, a method of charging a carbon powder in the gas diffusion layer to establish both the gas and water diffusion properties has been proposed. Moreover, in Japanese Patent Application Laid-Open No. 2000-160056, a method of defining pore size distributions of the catalyst layer and gas diffusion layer to enhance mobility of water in an interface between the catalyst layer and the gas diffusion layer has been proposed.

In this manner, attempts have been made to adjust porosity and pore size and to enhance both the gas diffusion property and water dragging property in the interface between the catalyst layer and the gas diffusion layer, but a shape of the interface has not been considered.

However, concave/convex portions exist on the surface of the gas diffusion layer which seems to be smooth, catalyst drops in the concave portion, and accordingly a portion in which the catalyst layer thickens locally exists. A reaction gas does not easily reach an area where the catalyst layer locally thickens, and therefore this is considered to contribute to reaction.

Therefore, it has been apparent that in order to enhance the cell performance, an interface shape between the catalyst layer and the gas diffusion layer needs to be flattened so as to obtain an entirely uniformly thin catalyst layer.

This problem is considered to be common in the fuel cell including the cell in which the catalyst layer is stacked on the gas diffusion layer.

The present invention has been developed in consideration of the problem, and an object thereof is to provide a fuel cell in which the interface shape between the catalyst layer and the gas diffusion layer is flattened/smoothened to enhance a catalyst utilization and to enhance performances of the cell such as a cell voltage or to reduce a catalyst amount.

### SUMMARY OF THE INVENTION

To achieve the object, according to the present invention, there is provided an electrode for a fuel cell comprising: a catalyst layer; and a gas diffusion layer stacked on the catalyst layer, wherein an arithmetic average roughness Ra of the surface of the gas diffusion layer on a side in contact with the catalyst layer is adjusted to be 15 μm or less, preferably in a range of 0.012 μm or more and 5 μm or less.

According to the present invention, when the catalyst layer is formed on the gas diffusion layer, the catalyst layer is prevented from dropping into a concave portion in the surface of the gas diffusion layer, and a thin and uniform catalyst layer can be formed. Therefore, there is a decrease of a region which does not react because a gas does not spread over the catalyst layer, a reaction gas can be supplied to the whole catalyst layer, and therefore a catalyst utilization is enhanced.

In the present invention, the gas diffusion layer includes a structure in which a carbon powder is charged in a porous carbon substrate.

In the present invention, since the carbon powder is charged in the hole of carbon paper constituting the substrate of the gas diffusion layer, it is possible to adjust the surface roughness of the gas diffusion layer to be small. Moreover, since the pore size and porosity of the gas diffusion layer can arbitrarily set, it is possible to adjust a condition on which water pooled in the anode and cathode is easily discharged. Therefore, the thin and uniform catalyst layer can be formed, the water can be prevented from being pooled, and therefore a cell voltage can be prevented from dropping because the reaction gas does not spread over the catalyst layer.

According to another aspect of the present invention, there is provided a fuel cell comprising: a cell including a proton exchange membrance, an anode in which a catalyst layer is stacked on a gas diffusion layer and whose catalyst layer is disposed on one surface of the proton exchange membrance, and a cathode in which the catalyst layer is stacked on the gas diffusion layer and whose catalyst layer is disposed on the other surface of the proton exchange membrance; a first plate which is disposed opposite to the gas diffusion layer of the anode and via which a fuel gas supplied to the anode is circulated; and a second plate which is disposed opposite to the gas diffusion layer of the cathode and via which an oxidant gas supplied to the cathode is circulated and which holds the cell together with the first plate, wherein the above-described electrode for the fuel cell is used in at least one of the cathode and the anode.

In the present invention, the fuel cell is prepared using the electrode in which a catalyst utilization in the catalyst layer is enhanced. Therefore, it is possible to enhance the cell performance in a catalyst amount equivalent to a conventional amount. Alternatively, it is possible to reduce the catalyst amount for use in obtaining the cell performance equivalent to the conventional performance.

### BRIEF DESCRIPTION OF THE DRAWINGS

FIG. 1 is a major part assembly diagram showing a constitution of a proton-exchange film fuel cell;

FIG. 2 is a schematic sectional view of a cell unit shown in FIG. 1;

FIG. 3 is a schematic sectional view schematically showing inner structures of an anode and cathode;

FIG. 4 is a schematic enlarged view of an interface between a gas diffusion layer and catalyst layer of the cathode shown in FIG. 4; and

FIG. 5 is a schematic enlarged view of the interface between the gas diffusion layer and catalyst layer of Example 1.

### DESCRIPTION OF THE PREFERRED EMBODIMENT

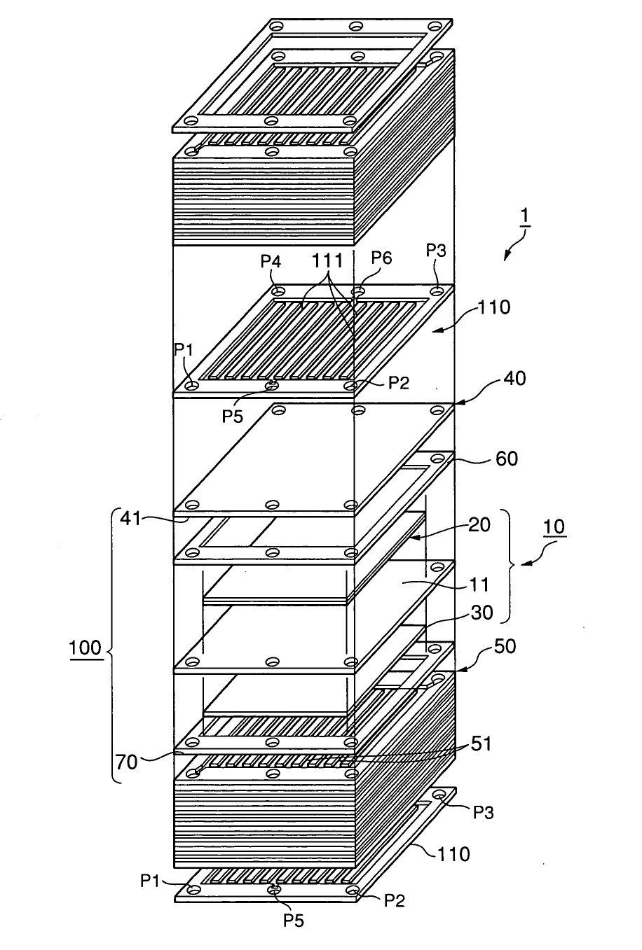

FIG. 1 is a major part assembly diagram showing a constitution of a polymer electrolyte fuel cell 1.

The fuel cell 1 includes a constitution in which a large number of cell units 100 are stacked, opposite ends of stacked layers are held by end plates (not shown), and cooling plates 110 are disposed every several stacked cell units 100.

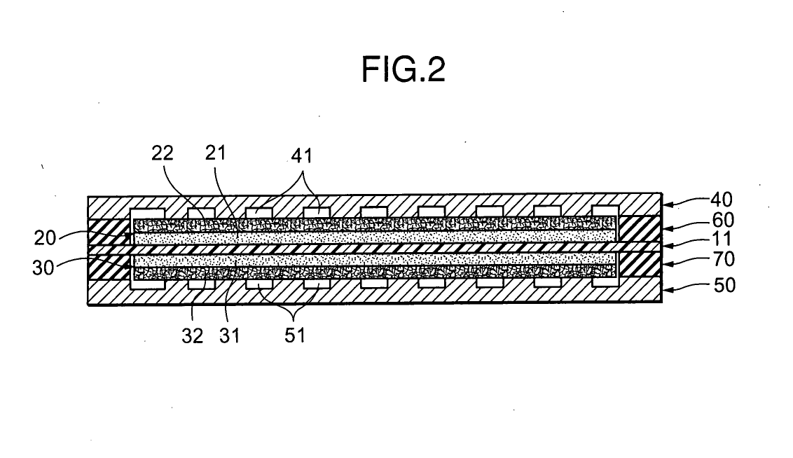

For each cell unit 100, a cell 10 constituted of an anode 20 formed on one surface of a proton exchange membrance 11 and a cathode 30 formed on the other surface is held between a separator plate 40 in which anode-side channels 41 are formed (in FIG. 1, the anode-side channels 41 are not seen because the channels are disposed in a rear surface of the separator plate, and therefore refer to FIG. 2) and a separator plate 50 in which cathode-side channels 51 are formed. In this constitution, gaskets 60, 70 are disposed to seal between outer peripheral portions of the proton exchange membrance 11 and those of the separator plates 40, 50.

The proton exchange membrance 11 is a thin film formed of a cation-exchange resin (perfluorocarbon sulfonic acid), and is, for example, a Nafion film (Du Pont K.K.).

Both the anode 20 and the cathode 30 have a structure in which a catalyst layer formed of carbon carrying a platinum-based catalyst, and a gas diffusion layer including carbon particles charged in carbon paper subjected to a water-repellent treatment are stacked, and the structure is closely attached and molded onto a middle portion of the proton exchange membrance 11 by hot press.

The separator plates 40, 50 are substrates which are obtained by processing dense carbon plates and which have conductivity. The cooling plates 110 is similarly a conductive and dense substrate.

Through holes P1 to P4 constituting a manifold for supplying/discharging the reaction gas are formed in corner portions of the separator plates 40, 50 and cooling plates 110. It is to be noted that the through holes P2, P4 communicate with the anode-side channels 41 of the separator plate 40, and the through holes P1, P3 communicate with the cathode-side channels 51 of the separator plate 50. Through holes P5, P6 constituting a manifold for inflow/outflow of a cooling water are formed in middle portions of one pair of opposite sides of the respective plates, and the through holes P5, P6 communicate with cooling water channels 111 disposed in the cooling plates 110.

In the fuel cell 1 structured in this manner, a fuel gas is supplied to the manifold for supplying the fuel gas, and air is supplied to the manifold for supplying the oxidant gas. It is to be noted that usually as the fuel gas, a hydrogen-rich modified gas, a pure hydrogen gas, and the like are used.

Moreover, the fuel gas supplied to the manifold for supplying the fuel gas is distributed into the respective anode-side channels 41 and supplied to the anode 20. This fuel gas is humidified by a humidifying device (not shown), and the proton exchange membrance 11 is wetted by moisture contained in this fuel gas.

On the other hand, the air supplied to the manifold for supplying the oxidant gas is supplied to the cathode 30 from the cathode-side channels 51. Moreover, a surplus gas is discharged via the manifold for discharging the oxidant gas. It is to be noted that this air is also humidified by a humidifier and then supplied.

Moreover, the cooling water is supplied to the manifold for the inflow of the cooling water, and the cooling water supplied to the manifold is distributed into the respective cooling water channels 111. The fuel cell 1 generates heat with power generation, but is cooled with this cooling water, and is maintained at a predetermined run temperature (70 to 80° C.).

(Description of Effect by Anode and Cathode of the Present Embodiment)

FIG. 2 is a schematic sectional view of the cell unit 100.

The fuel gas supplied to the anode-side channels 41 is passed through a gas diffusion layer 22 of the anode 20, and is used in reaction (2H₂→4H⁺+4e⁻) in a catalyst layer 21. A part of moisture contained in the fuel gas is transmitted through the gas diffusion layer 22, catalyst layer 21, and proton exchange membrance 11, and moves toward the cathode 30.

On the other hand, the air supplied to the cathode-side channels 51 is passed through a gas diffusion layer 32 of the cathode 30, and is used in reaction (4H⁺+O₂+4e³¹ →2H₂O) in a catalyst layer 31. Generated water and water moving from the anode 20 side involved in the reaction are passed through the catalyst layer 31 and gas diffusion layer 32, and diffused in the air circulated through the cathode-side channels 51. However, a part of water exists as liquid in the cathode 30. Therefore, unless water that is liquid can smoothly move in the layers of the cathode 30, the water that is liquid pools in the layers of the cathode 30.

When much water that is liquid pools in the layers of the anode 20 and cathode 30, a reaction area of the catalyst layer 21 or the catalyst layer 31 decreases. Additionally, the fuel gas or air does not easily spread over the catalyst layer 21 or the catalyst layer 31, and this causes a drop of the cell voltage. Therefore, the gas diffusion layers 22, 32 require the water dragging property together with the gas diffusion property.

(Detailed Description on Constitutions of Anode and Cathode)

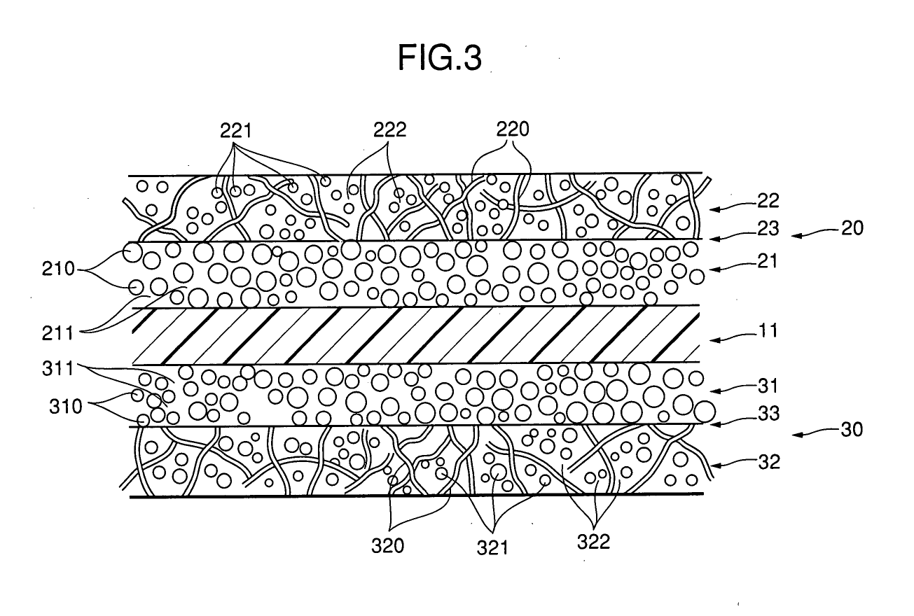

FIG. 3 is a schematic sectional view schematically showing the inner structure of the cell 10.

For the catalyst layer 21 in the anode 20, a mixture obtained by mixing carbon particles 210 carrying a platinum-based catalyst and an ion exchange resin is formed in layers on the surface of the gas diffusion layer 22. For the gas diffusion layer 22, holes in porous carbon paper subjected to the water-repellent treatment using a fluorocarbon resin are filled with a mixture of carbon particles 221 and a water-repellent resin.

Moreover, the catalyst layer 31 in the cathode 30 also has a constitution similar to that of the anode 20. A mixture obtained by mixing carbon particles 310 carrying the platinum-based catalyst with the ion exchange resin is formed in the layers on the surface of the gas diffusion layer 32. For the gas diffusion layer 32, the holes in the porous carbon paper subjected to the water-repellent treatment are filled with the mixture of carbon particles 321 and the water-repellent resin.

In the anode 20 and cathode 30, the layer is held in the middle portion of the proton exchange membrance 11 and closely attached/molded by the hot press on conditions at 120° C. and 50 kgf/cm² to constitute the cell 10.

### EXAMPLE 1

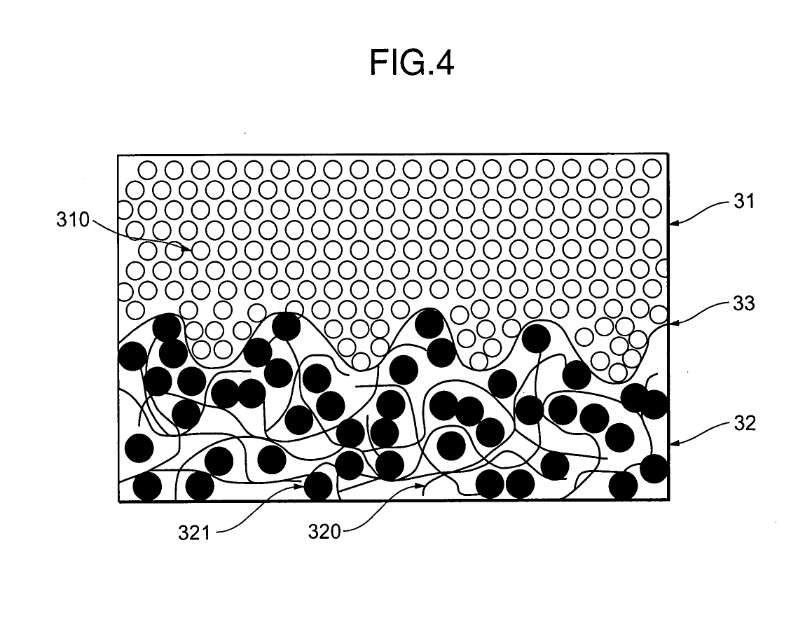

FIG. 4 is a schematic enlarged view of the interface between the catalyst layer 31 and the gas diffusion layer 32 of the cathode 30. In the present embodiment, the cathode will be described, and the present invention is not limited to the cathode.

An interface 33 between the catalyst layer 31 and the gas diffusion layer 32 includes concave/convex portions when seen in a micro size, and a catalyst 310 drops in the concave portion of the gas diffusion layer 32. In this portion, the catalyst 310 locally thickens, and the air does not easily spread. As a result, a region is produced where the reaction contributing to the power generation does not occur, and this drops an utilization of the catalyst layer 31.

To solve the problem, in Example 1, in order to flatten/smoothen the concave/convex portions of the gas diffusion layer 32, two types of carbon powders different from each other in particle size are prepared. When charging the carbon powder in the carbon paper, the powder is divided and applied twice depending on the particle size.

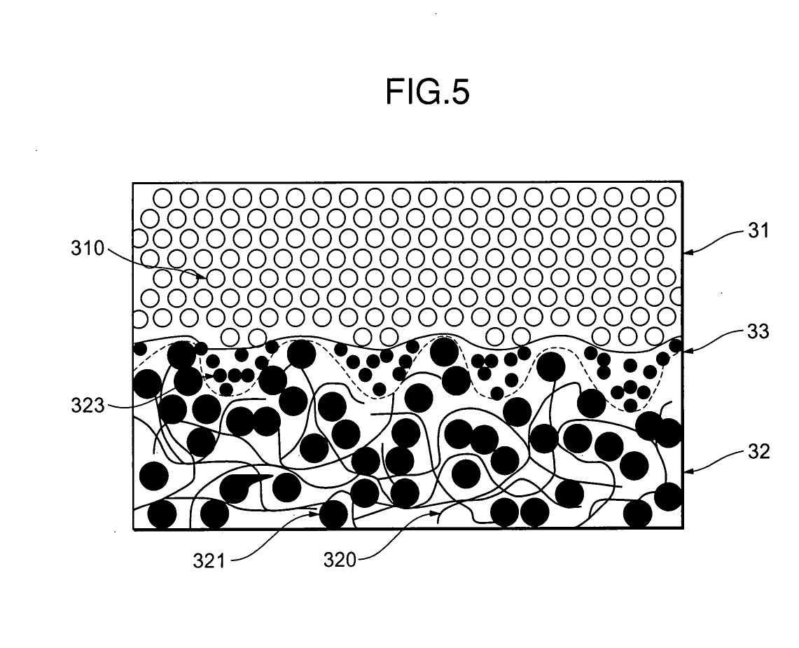

FIG. 5 is a schematic enlarged view of the interface 33 between the catalyst layer 31 and the gas diffusion layer 32 at the time of the use of the carbon powder having two types of particle sizes.

For the gas diffusion layer, the carbon paper having a thickness of about 200 μm was immersed in a dispersion solution of tetrafluoroethylene-hexafluoropropylene copolymer (FEP), and calcined at 380° C. for one hour to perform the water-repellent treatment.

Moreover, a carbon powder (manufactured by Cabot Co., Vulcan XC-72) passed through a sieve with 200 meshes (about 75 μm), polytetrafluoroethylene (PTFE), and solvent were mixed to prepare carbon paste (1).

Subsequently, the carbon paper subjected to the water-repellent treatment was coated with the carbon paste (1) to prepare a conventional gas diffusion layer. After drying this layer, a carbon powder having a particle size smaller than that of a carbon powder XC-72 was used to prepare carbon paste (2), and the layer was coated this paste to prepare the gas diffusion layer 32 of Example 1. The carbon powder having a small particle size is commercially available, and may also be obtained by passing XC-72 through a sieve with further fine mesh or crushing the powder.

As shown in FIG. 5, the concave portions of the conventional gas diffusion layer are smoothened by carbon powder 323 having a small particle size, and the catalyst layer 31 on the gas diffusion layer 32 can also uniformly be formed.

### EXAMPLE 2

In Example 2, a solvent amount was increased than before, and the carbon powder XC-72 was mixed with PTFE to prepare carbon paste (3). Subsequently, after preparing and drying the conventional gas diffusion layer, the conventional gas diffusion layer was coated with the carbon paste (3) to prepare the gas diffusion layer 32 of Example 2.

By the above-described method, the carbon paste (3) having a low viscosity flows in to flatten/smoothen the concave portions of the conventional gas diffusion layer, and the catalyst layer on the gas diffusion layer 32 can uniformly be formed.

### EXAMPLE 3

In Example 3, the solvent amount was further increased as compared with the carbon paste (3) to prepare carbon paste (4) having the low viscosity. Moreover, the paste was sprayed onto the conventional gas diffusion layer to prepare the flat/smooth gas diffusion layer 32.

### EXAMPLE 4

In Example 4, after preparing the conventional gas diffusion layer, the hot press was carried out. Since a step of the hot press is added after forming the gas diffusion layer, the gas diffusion layer 32 is flattened/smoothened, and the catalyst layer 31 can uniformly be formed.

### COMPARATIVE EXAMPLE

For the gas diffusion layer 32 of a comparative example, the carbon paper having a thickness of about 200 μm was immersed in an FEP dispersion solution, and calcined at 380° C. for one hour to perform the water-repellent treatment as heretofore done. The carbon paper subjected to the water-repellent treatment was coated with the carbon paste (1) to prepare the gas diffusion layer 32.

(Surface Roughness Measurement)

After sufficiently drying the surface of the gas diffusion layer of Examples 1 to 4 and the comparative example, a non-contact type surface roughness measuring instrument was used to measure an arithmetic average roughness Ra of the surface of the gas diffusion layer.

As a result of the measurement, the arithmetic average roughness Ra of the comparative example was 15 μm. The arithmetic average roughness of Examples 1 to 4 was reduced as compared with the comparative example as shown in Table 1.

However, it is impossible to set the arithmetic average roughness Ra of the gas diffusion layer to be smaller than the particle size of the carbon powder charged into the gas diffusion layer, and a lower limit of the average surface roughness Ra is considered to depend on the particle size of the carbon powder. That is, since the carbon powder having a particle size of 50 to 70 μm is used in the conventional gas diffusion layer surface, a maximum height Ry is about 60 μm. When this is converted to the arithmetic average roughness Ra, the value is 15 μm, and agrees with a measured value. Therefore, when the carbon powder is crushed to the limit (a coagulated body is decomposed into individual particles), the particle size is about 0.05 μm. Therefore, the maximum height Ry is 0.05 μm, and the lower limit is considered to be 0.012 μm in accordance with the arithmetic average roughness Ra.

(Power Generation Test)

The mixture of the carbon particles carrying the platinum-based catalyst and the ion exchange resin was formed by the same amount in the layers on the surfaces of the gas diffusion layers of the respective examples and comparative example to prepare the anode and cathode. In this test, an amount of carried platinum was set to 0.2 mg/cm². The anode and cathode were used to prepare the cell, and the cell voltage was measured on the following run conditions.

| | | |
|---|---|---|
| Current density: | 0.5 | A/cm² |
| Cell temperature: | 70° | C. |

| | |
|---|---|
| Fuel gas: | H₂ |
| Oxidant gas: | air |
| Fuel gas utilization: | 70% |
| Oxidant gas utilization: | 40% |

The result of the power generation test is shown in Table 1.

TABLE 1

| Gas diffusion | Arithmetic average | Cell |
|---|---|---|
| layer | roughness Ra | voltage |
| Example 1 | 1.5 μm | 690 mV |
| Example 2 | 8 μm | 682 mV |
| Example 3 | 5 μm | 688 mV |
| Example 4 | 11 μm | 674 mV |
| Comparative | 15 μm | 660 mV |
| example | | |

In these cells, although the catalyst amount was the same, the cell voltages of Examples 1 to 4 treated so as to flatten/smoothen the surface of the gas diffusion layer were higher than that of the comparative example. Above all, a satisfactory result was obtained in the cell having the arithmetic average roughness Ra of 5 μm or less.

As described above, in accordance with the present invention, when an average surface roughness is reduced in an interface between a catalyst layer and a gas diffusion layer to form the catalyst layer on the gas diffusion layer, the catalyst layer is prevented from dropping into an opening of the gas diffusion layer, and a catalyst utilization can be enhanced.

What is claimed is:

1. An electrode for a fuel cell comprising: a catalyst layer; and a gas diffusion layer stacked on the catalyst layer,
wherein an arithmetic average roughness Ra of the surface of the gas diffusion layer on a side in contact with the catalyst layer is 15 μm or less.

2. The electrode for the fuel cell according to claim 1, wherein the arithmetic average roughness Ra of the surface of the gas diffusion layer on the side in contact with the catalyst layer is in a range of 0.012 to 5 μm.

3. The electrode for the fuel cell according to claim 1 or 2, wherein the gas diffusion layer includes a structure in which a carbon powder is charged in a porous carbon substrate.

4. A fuel cell comprising:
a cell including a proton exchange membrance, an anode in which a catalyst layer is stacked on a gas diffusion layer and whose catalyst layer is disposed on one surface of the proton exchange membrance, and a cathode in which the catalyst layer is stacked on the gas diffusion layer and whose catalyst layer is disposed on the other surface of the proton exchange membrance;
a first plate which is disposed opposite to the gas diffusion layer of the anode and via which a fuel gas supplied to the anode is circulated; and
a second plate which is disposed opposite to the gas diffusion layer of the cathode and via which an oxidant gas supplied to the cathode is circulated and which holds the cell together with the first plate,
wherein the electrode for the fuel cell according to any one of claims 1 to 3 is used in at least one of the anode and the cathode.
